(19) United States
(12) Patent Application Publication
(10) Pub. No.: US 2008/0058974 A1
(43) Pub. Date: Mar. 6, 2008

(54) Tire designing method, computer-readable recording medium, and tire manufacturing method

(76) Inventors: Sachio Nakamura, Kanagawa (JP); Yasujiro Daisho, Kanagawa (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/895,039

(22) Filed: Aug. 21, 2007

(30) Foreign Application Priority Data
Aug. 22, 2006 (JP) 2006-225230

(51) Int. Cl. G06F 19/00

(52) U.S. Cl. 700/97

(57) ABSTRACT

Evaluation tires, each having a plurality of structural elements including a target structural element, are prepared. Only the experimental structure of the target structural element is different among all the evaluation tires, while the structures of other structural elements are identical. Radial force variation of each of the evaluation tires is measured. Corrected radial-force variation of each of the evaluation tires is calculated by subtracting a 1st order component of the radial force variation from the radial force variation, and the structure of the target structural element is determined based on the corrected radial-force variations of the evaluation tires. This process is repeated for other structural elements.

### CROSS-REFERENCE TO RELATED APPLICATIONS

This application claims the benefit and priority to Japanese Application Number 2006-225230 filed on Aug. 22, 2006, the disclosure of which is hereby incorporated by reference in its entirety.

### BACKGROUND OF THE INVENTION

1. Field of the Invention

The present invention generally relates to tires, and specifically relates to methods of designing and manufacturing tires.

2. Description of the Related Art

When a tire rotates under a load, it is desirable that the reaction variation caused with respect to the rotation axis of the tire is constant along the circumference of the tire. To realize such constant variation, it is necessary that inner rigidity, size, mass distribution, and the like (hereinafter, tire properties) are even in the tire along the tire circumferential direction. The evenness of the tire properties is collectively referred to as “tire uniformity”. A tire has a complex structure including rubber, steel cords, and fibers. Because of the structural and manufacturing constrains, it is difficult to manufacture a tire having perfectly tire uniformity along the circumference.

The non-uniformity of the tire properties may result in vehicle vibration such as “shakes” or “flutter”, and vehicle interior noises such as “booming noise” or “beat noise”. Hence, it is desirable that the tire properties are uniform in the tire circumferential direction. For example, Japanese Patent Application Laid-open No. 2005-534540 discloses a method of improving high-speed uniformity of a tire by using multivariate statistics and the like. In this method, the position of the tire is determined where the relation between low-speed uniformity and a vector of mass imbalance and vectors of other characteristics is optimum, and then the position of the tire is determined where the sum of the vectors is offset during high-speed moving of a vehicle.

Because the technology disclosed in Japanese Patent Application Laid-open No. 2005-534540 is used to evaluate a tire that is mounted on the rim of a wheel, the unevenness of the wheel and the rim affects the evaluation. Hence, the evaluation results are not for the tire only but for the tire-wheel assembly, which makes it difficult to evaluate and improve the uniformity of the tire.

### SUMMARY OF THE INVENTION

It is an object of the present invention to at least partially solve the problems in the conventional technology.

According to an aspect of the present invention, there is provided a method of designing a tire includes preparing a plurality of evaluation tires, each of the evaluation tires having a plurality of structural elements including a target structural element, such that an experimental structure of the target structural element is different among all the evaluation tires while structures of structural elements other than the target structural element are identical among all the evaluation tires; measuring a radial force variation of each of the evaluation tires; calculating a corrected radial-force variation of each of the evaluation tires by subtracting a 1st order component of the radial force variation from the radial force variation; determining a structure of the target structural element based on the corrected radial-force variations of the evaluation tires; and selecting another structural element from among the structural elements as a new target structural element and repeating the preparing, the measuring, the obtaining, and the determining for the new target structural element thereby determining structures of all the structural elements.

According to another aspect of the present invention, there is provided a computer-readable recording medium that stores therein a computer program that causes a computer to execute the above method.

According to still another aspect of the present invention, there is provided a method of manufacturing a tire including preparing a plurality of evaluation tires, each of the evaluation tires having a plurality of structural elements including a target structural element, such that an experimental joining position where edges of the target structural element are joined is different among all the evaluation tires, the experimental joining positions of the evaluation tires corresponding to positions where the tire is divided into parts with respect to a rotation axis of the tire, while structures of structural elements other than the target structural element are identical among all the evaluation tires; measuring a radial force variation of each of the evaluation tires; calculating a corrected radial-force variation of each of the evaluation tires by subtracting a 1st order component of the radial force variation from the radial force variation; determining a joining position of the target structural element based on the corrected radial-force variations of the evaluation tires; and selecting another structural element from among the structural elements as a new target structural element and repeating the preparing, the measuring, the obtaining, and the determining for the new target structural element thereby determining joining positions of all the structural elements; and joining the edges of each of the structural elements at the joining positions determined at the determining.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a partial meridian cross section of a typical pneumatic tire;

FIG. 2A is a graph of an example of RFV of a tire/wheel assembly at a low rolling speed;

FIG. 2B is a graph of an example of RFV of the tire/wheel assembly at a high rolling speed;

FIG. 3A is a graph of a relation between rolling speed and a 1st order component of RFV;

FIG. 3B is a graph of a relation between rolling speed and a phase angle of the 1st order component of RFV;

FIG. 4A is a graph of an example of corrected RFV of the tire/wheel assembly at the low rolling speed;

FIG. 4B is a graph of an example of corrected RFV of the tire/wheel assembly at the high rolling speed;

FIG. 5 is a block diagram of a tire designing device according to an embodiment of the present invention;

FIG. 6 is a flowchart of a tire designing method according to the embodiment of the present invention; and

FIGS. 7A, 7B, and 7C are schematic diagrams of tires for explaining the tire designing method.

### DETAILED DESCRIPTION OF THE PREFERRED EMBODIMENT

Exemplary embodiments of the present invention are explained in detail below with reference to the accompanying drawings. The present invention is not limited to the embodiments.

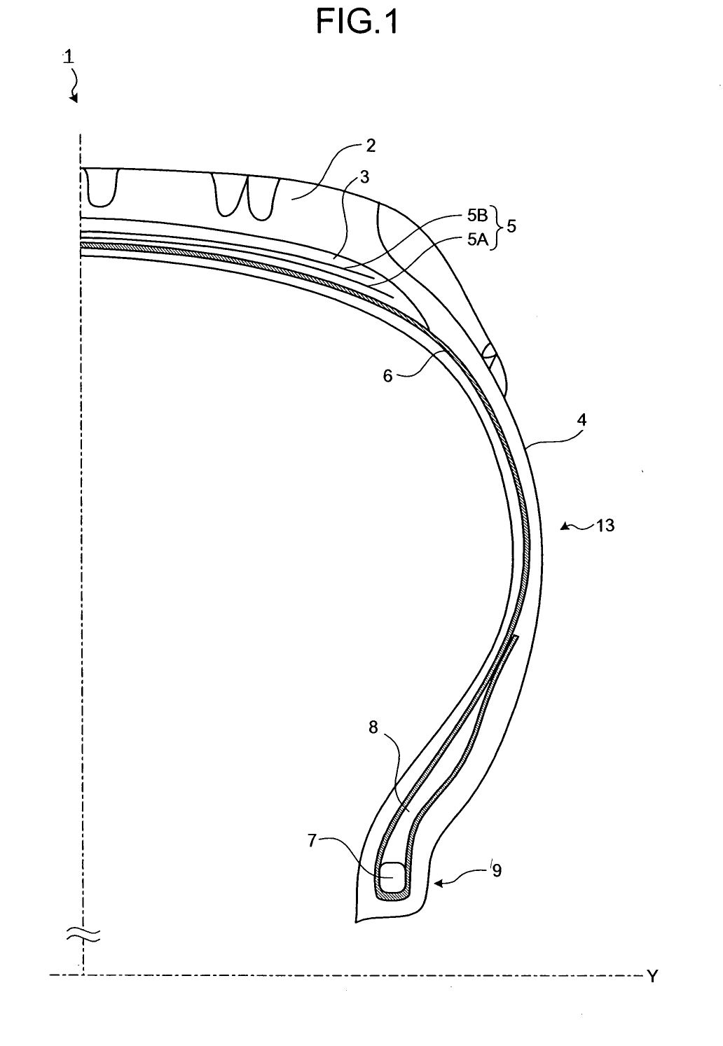

FIG. 1 is a partial meridian cross section of a typical pneumatic tire 1. The dashed-and-dotted line Y represents the rotation axis of the tire 1. The tire 1 is a complex structure including structural elements such as rubber, steel cords, and fibers as explained below. A cap tread 2 is a rubber layer that is in contact with the road surface and covers the outer surface of a carcass 6, a first belt 5A and a second belt 5B (collectively referred to as a “belt 5”). An under tread 3 is a rubber layer positioned between the cap tread 2 and the belt 5. A side tread 4 is positioned at the outermost portion of a sidewall 13. The presence of the side tread 4 protects the carcass 6 from damage due to external forces. The belt 5 is a cord layer laminated with rubber positioned between the cap tread 2 and the carcass 6. In a radial pneumatic tire, the belt 5 functions as a reinforcing member that keeps the shape of the tire 1. The carcass 6 is a cord layer laminated with rubber serving as the backbone member of the tire 1, and it is the reinforcing member that serves as a pressure container when the tire 1 is inflated.

A bead 9 is a ring-shaped member that is formed with hard rubber, a bundle of steel wires. The bundle of steel wires is a bead core 7. Because of the bead 9, the tire 1 can be fixed on the rim of a wheel. The carcass 6, the belt 5, the cap tread 2, the under tread 3, the side tread 4, and the bead 9 are reinforcing members of the tire 1. A bead filler 8 is a hard rubber that is filled in a space formed when the carcass 6 is turned around the bead core 7. The bead filler 8 functions to increase the stiffness of the bead 9.

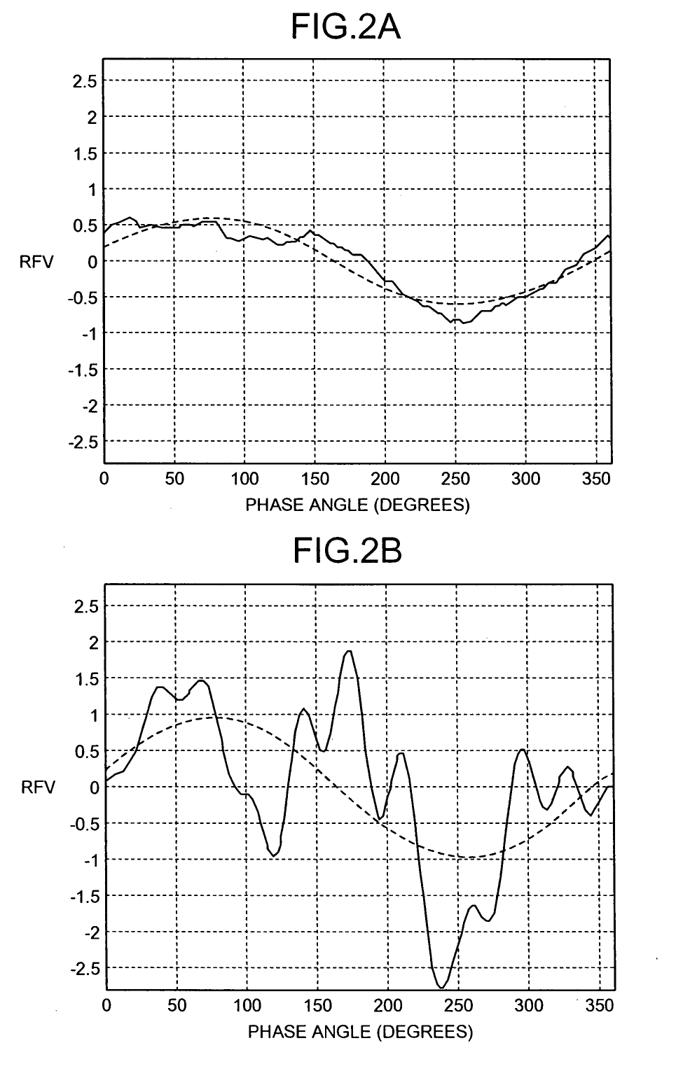

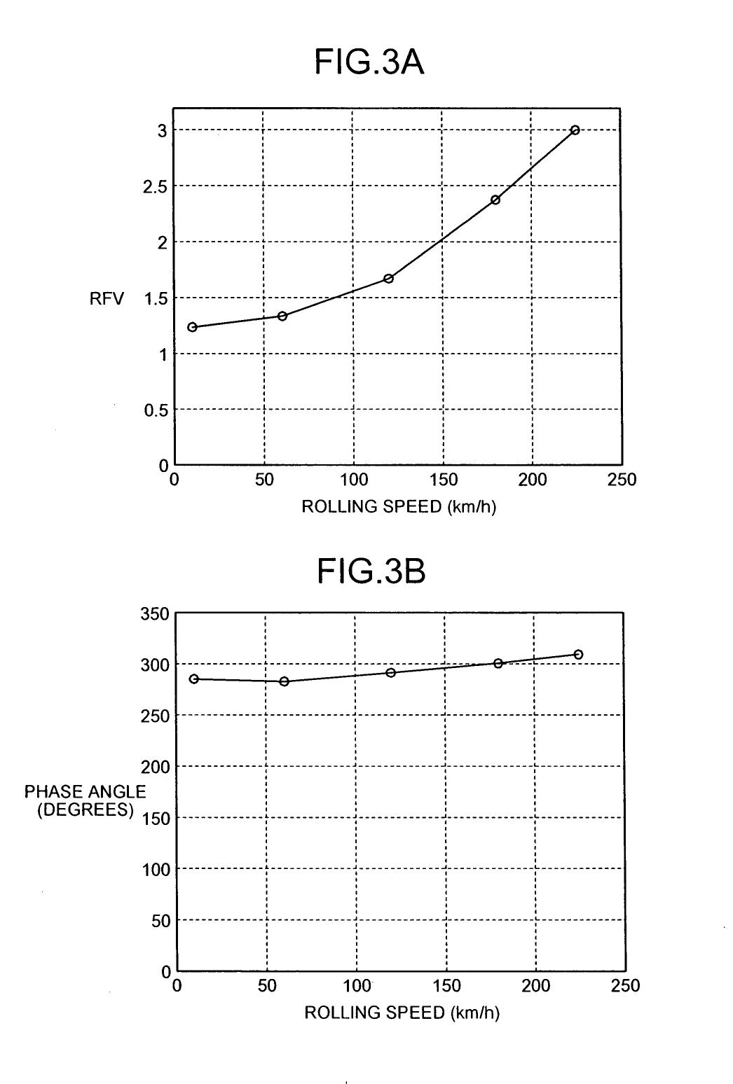

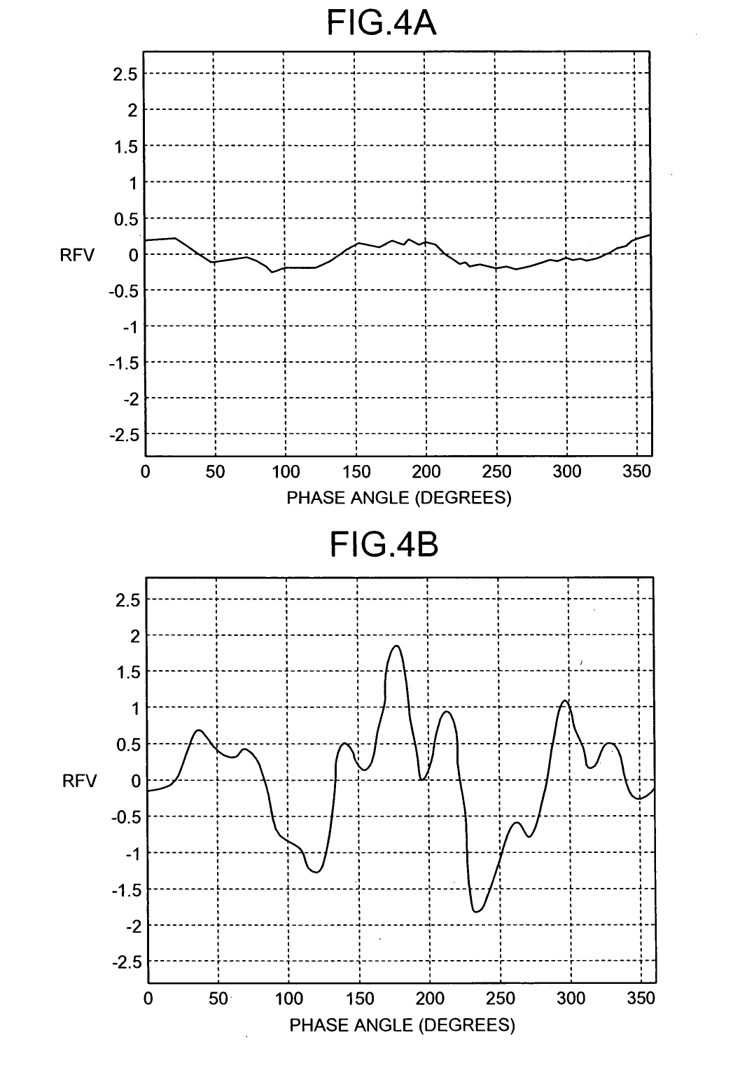

FIG. 2A is a graph of an example of radial force variation (RFV) of a tire/wheel assembly at a low rolling speed of 10 km/h. FIG. 2B is a graph of an example of RFV of the tire/wheel assembly at a high rolling speed of 225 km/h. FIG. 3A is a graph of a relation between rolling speed and a 1st order component of RFV. FIG. 3B is a graph of a relation between rolling speed and a phase angle of the 1st order component of RFV. FIG. 4A is a graph of an example of corrected RFV of the tire/wheel assembly at the low rolling speed. FIG. 4B is a graph of an example of corrected RFV of the tire/wheel assembly at the high rolling speed. The RFV is the variation of the force that appears in the rotating axis of a tire. The RFV and the corrected RFV shown in FIGS. 2A to 4B are relative values of measured values. The 1st order component of the RFV is can be gained by analyzing the RFV with Fourier series.

As shown in FIGS. 2A and 2B, the RFVs (solid lines) at the low rolling speed and that at the high rolling speed are quite different. On the other hand, the 1st order components (dashed lines) of the RFV at the low rolling speed and that at the high rolling speed are similar. As shown in FIG. 3A, the 1st order component of the RFV increases in a quadric manner as the rolling speed increases. On the contrary, the phase angle that the maximum RFV point is shown is not affected by the rolling speed.

The above results represent that the mounting of the tire on the wheel, including the unevenness of the rim, affects the 1st order component of the RFV. Thus, the uniformity of the tire only can be evaluated by subtracting the 1st order component of the RFV occurring in the tire/wheel assembly from the RFV.

The solid lines shown in FIGS. 4A and 4B represent corrected RFV obtained by subtracting the 1st order component from the RFV. The corrected RFV is not affected by how the tire is fit to the wheel. The uniformity of the tire only can be evaluated from the corrected RFV.

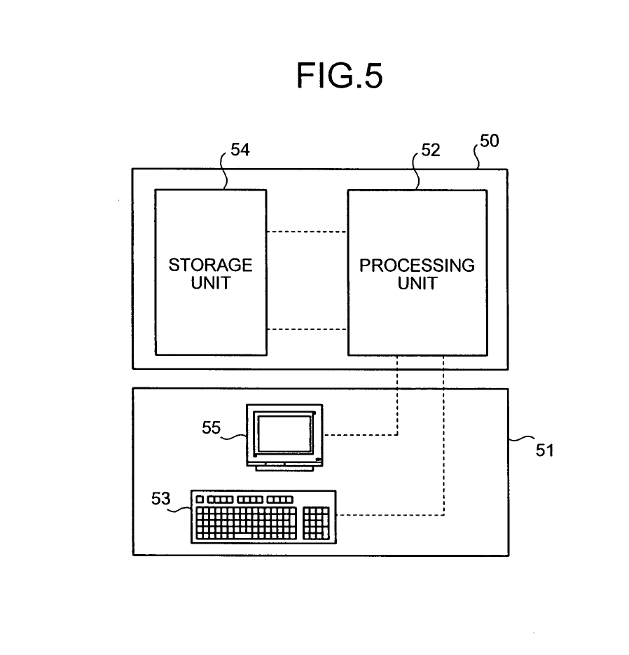

FIG. 5 is a block diagram of a tire designing device 50 according to the embodiment of the present invention. The tire designing device 50 includes a processing unit 52 and a storage unit 54. An input/output (I/O) unit 51 that includes an input unit 53 and a display unit 55 is connected to the tire designing device 50. Information necessary for designing a tire is input to the processing unit 52 or the storage unit 54 by using the input unit 53. Results of calculations are displayed on the display unit 55.

The input unit 53 can be an input device such as a keyboard and a mouse. The storage unit 54 stores therein computer programs for implementing the tire designing method. The storage unit 54 can be a non-volatile memory (a read-only memory (ROM)) such as a CD-ROM, a hard disk, a magneto optical disk, or a flash memory; a volatile memory such as a random access memory (RAM); or a combination of the above memories.

The computer program can be used in combination with computer programs previously stored in a computer system including an operation system (OS) and hardware devices such as peripheral devices to implement the tire designing method. Alternatively, the computer system can be made to read and execute the computer programs, which are recorded in a computer-readable recording medium, thereby implementing the tire designing method.

The processing unit 52 includes a memory (not shown) and a CPU (not shown). When designing a tire, the processing unit 52 reads the computer programs to the memory, and performs arithmetic calculations based on conditions for designing a tire, other input data, and the like. During the calculations, the processing unit 52 stores the calculated values in the storage unit 54 and reads the values from the storage unit 54. Instead of the computer program, the processing unit 52 can include a hardware device only for executing the above arithmetic operations. The results obtained by the calculations are displayed on the display unit 55.

The display unit 55 can be, for example, a cathode ray tube (CRT) or a liquid crystal display (LCD) device. A printer can be provided if necessary to output the calculated results. The storage unit 54 can be built in the processing unit 52, or built in another device (for example, a database server). As an example of the latter case, the tire designing device 50 can access the processing unit 52 or the storage unit 54 using a terminal device including the I/O unit 51.

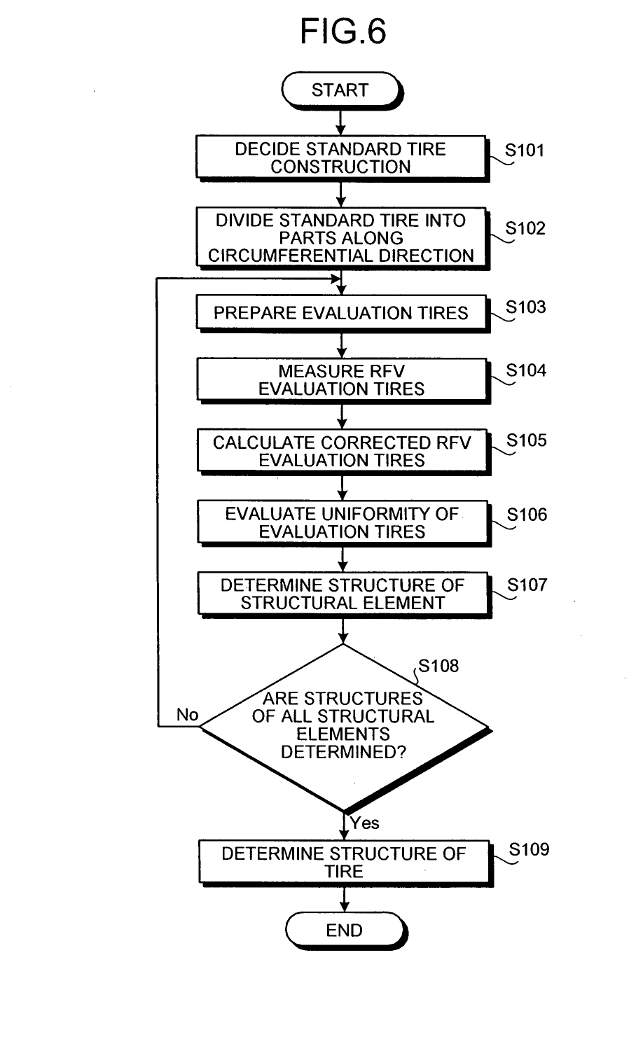

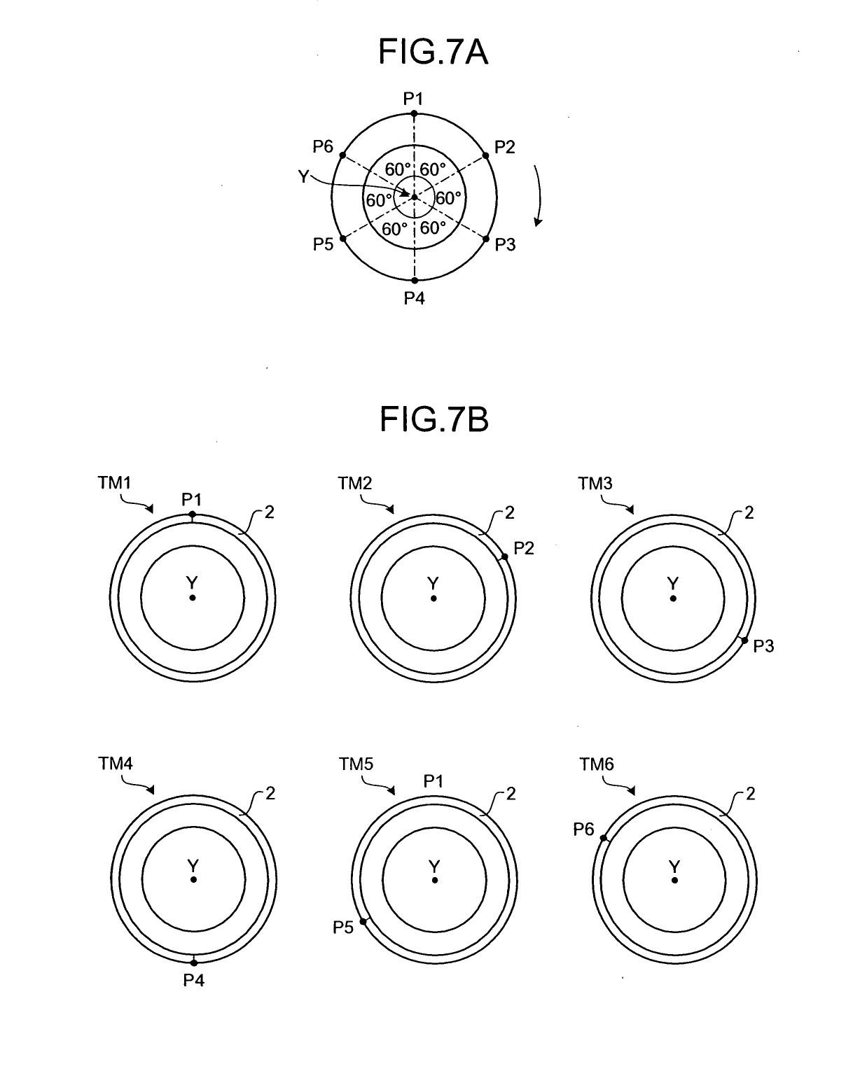

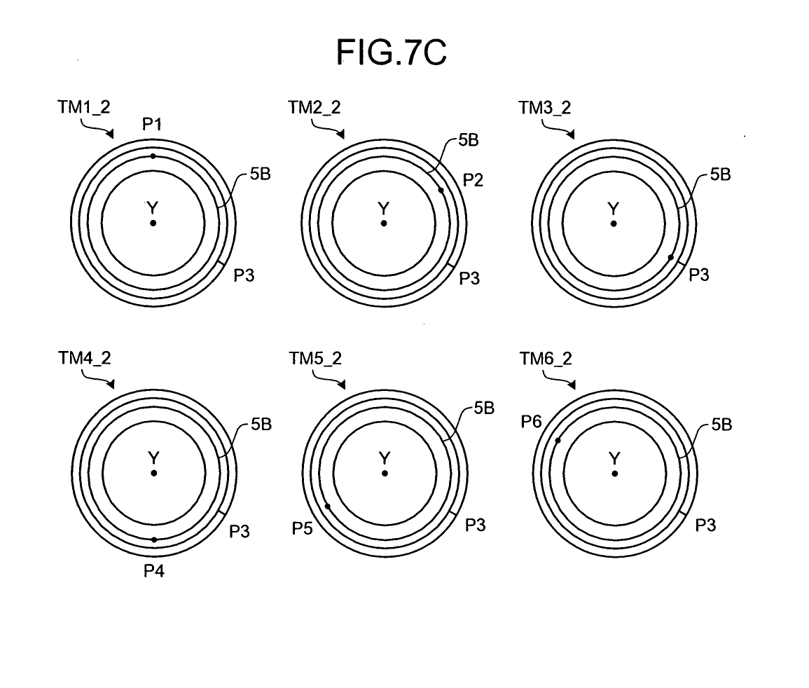

FIG. 6 is a flowchart of the tire designing method realized by the tire designing device 50. FIGS. 7A, 7B, and 7C are schematic diagrams of tires for explaining the tire designing method. Construction of a standard tire (for example, the tire 1) is decided (step S101). The standard tire is divided into a plurality of parts along the tire circumferential direction (step S102, see FIG. 7A), and structural-element changing positions P1 to P6 where one of structural elements of the standard tire, such as the carcass 6 or the belt 5, is to be changed are decided in the standard tire.

Only one structural element of the standard tire is changed at a time. In the embodiment, the structural element is changed at the structural-element changing positions P1 to P6 by which the standard tire is divided into six parts centering the rotation axis Y of the standard tire as shown in FIG. 7A. Each of the divided six parts has a center angle of 60 degrees. The standard tire can be divided into more than six parts. However, even if the standard tire is divided into a large number of parts, the efficiency in uniformity evaluation does not improve greatly, however, the manufacturing of a tire becomes difficult. For this reason, it is preferable that the number of divided parts is less.

The structural-element changing positions P1 to P6 are as shown in FIG. 7A. First, six evaluation tires TM1 to TM6 are prepared with the basic structure of the standard tire (step S103). Among the evaluation tires TM1 to TM6, for example, only the structure of the cap tread 2 is different while the rest of the structure is identical. That is, the edges of the cap tread 2 are joined at the structural-element changing positions P1 to P6 in the respective evaluation tires TM1 to TM6, and structures of the other structural elements including the belt 5 and the carcass 6 are identical among the evaluation tires TM1 to TM6 (FIG. 7B). Specifically, for example, the edges of the cap tread 2 of the evaluation tire TM1 are joined at the position P1, and the edges of the cap tread 2 of the evaluation tire TM6 are joined at the structural-element changing position P6.

As described above, in the embodiment, the edges of the cap tread 2 are joined at different positions among the evaluation tires TM1 to TM6. Alternatively, a physical property or a size (length, width, thickness) of a structural element (for example, the gage thickness of the cap tread 2) can be different among the evaluation tires TM1 to TM6.

RFV is measured for each of the evaluation tires TM I to TM6 (step SI 04). The RFV can be measured with a dedicated test machine. Alternatively, the RFV can be calculated by performing numerical analysis on analytical models of the evaluation tires TM1 to TM6 by using the finite element method (FEM).

After the performance of each of the evaluation tires TM1 to TM6 is evaluated, the processing unit 52 calculates corrected RFV of each of the evaluation tires TM1 to TM6 (step S105). The corrected RFV can be calculated by subtracting the 1st order component of the RFV from the RFV. In other words, the corrected RFV_C is calculated as follows:
RFV_{—}C=RFV_{—}E−RFV_{—}1
where RFV_E is RFV measured by the tests, and RFV_1 is a 1st order component of the RFV.

Subsequently, the uniformity of each of the evaluation tires TM1 to TM6 is evaluated based on the corrected RFV (step S106). For example, the evaluation tire that has the smallest average of corrected RFV in a speed range of the tire 1 is selected among the evaluation tires TM1 to TM6, or the evaluation tire that has the smallest corrected RFV at a certain speed (for example, at a high rolling speed) is selected.

Subsequently, the structure of the structural element of the evaluation tire having the smallest RFV (in the embodiment, the best joining position where the edges of the structural element are joined) among the evaluation tires TM1 to TM6 determined as the structure of the structural element of the standard tire (step S107). If the evaluation tire TM3 has the smallest RFV among the evaluation tires TM1 to TM6, for example, the position for joining the edges of the cap tread 2 of the standard tire is determined to be the position P3.

It is judged whether the structures of all the structural elements of the standard tire are determined (step S108). If all the structural elements have not been determined (No at step S108), steps S103 to S107 are repeated for the structural element whose structure has not been determined, for example, the second belt 5B.

Six evaluation tires TM1_2 to TM6_2 are prepared with the basic structure of the standard tire (step S103). Each of the evaluation tires TM1_2 to TM6_2 includes the cap tread 2 having the structure determined at step S106. Only the structure of the second belt 5B is different among the evaluation tires TM1_2 to TM6_2. Other structural elements including the cap tread 2 and the carcass 6 are not changed and are common in the evaluation tires TM1_2 to TM6_2 (see FIG. 7C). Specifically, the edges of the second belt 5 of the evaluation tire TM1_2 are joined at the structural-element changing position P1, and the edges of the second belt 5 of the evaluation tire TM6_2 are joined at the structural-element changing position P6. Thereafter, the steps S104 to S107 are repeated to determine the structure (the joining position) of the second belt 5B. When the structures of all the structural elements are decided (Yes at step S108), the structure of a tire is determined (step S109).

To manufacture a tire including the structural elements having the structures determined by using a tire manufacturing method of the embodiment, for example, attachment of the cap tread 2 and the second belt 5 is performed such that the edges of each structural elements are joined at the appropriate structural-element changing position determined with the above tire designing method. The number of evaluation tires can be reduced by employing design of experiments (DOE). In addition, the simplex method can be employed for determining the structure (a joining position, a thickness, a material) of a structural element.

In the embodiment, the evaluation tires, each including one structural element different among the evaluation tires, are prepared based on a standard tire, and the RFV of each of the evaluation tires is measured. By subtracting the 1st order component of the RFV from the RFV, the corrected RFV of each of the evaluation tires is calculated. Based on the corrected RFV, the uniformity of each of the evaluation tires is evaluated and the structure of the standard tire is determined. In this manner, the uniformity of the tire only excluding the influence of the mounting of the tire on the wheel can be evaluated. Because it suffices that the number of structural-element changing positions by which the standard tire is divided into parts along the tire circumferential direction are six, the number of the evaluation tires can be reduced, which improves the efficiency in designing a tire.

According to an aspect of the present invention, the uniformity of the tire can be improved easily and inexpensively.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of designing a tire comprising:
preparing a plurality of evaluation tires, each of the evaluation tires having a plurality of structural elements including a target structural element, such that an experimental structure of the target structural element is different among all the evaluation tires while structures of structural elements other than the target structural element are identical among all the evaluation tires;
measuring a radial force variation of each of the evaluation tires;
calculating a corrected radial-force variation of each of the evaluation tires by subtracting a 1st order component of the radial force variation from the radial force variation;
determining a structure of the target structural element based on the corrected radial-force variations of the evaluation tires; and
selecting another structural element from among the structural elements as a new target structural element and repeating the preparing, the measuring, the obtaining, and the determining for the new target structural element thereby determining structures of all the structural elements.

2. The method according to claim 1, wherein the structure of the structural element includes a joining position where two edges of the structural element are joined.

3. The method according to claim 1, wherein the structure of the target structural element is different at certain positions of the evaluation tires, the certain positions corresponding to positions of the tire where the tire is divided into parts with respect to a rotation axis of the tire, each of the parts having a center angle of 60 degrees.

4. The method according to claim 1, wherein the structure of the target structural element is different at certain positions of the evaluation tires, the certain positions corresponding to positions of the tire where the tire is divided into parts with respect to a rotation axis of the tire, each of the parts having a center angle of 30 degrees.

5. A computer-readable recording medium that stores therein a computer program that causes a computer to execute:
preparing a plurality of evaluation tires, each of the evaluation tires having a plurality of structural elements including a target structural element, such that an experimental structure of the target structural element is different among all the evaluation tires while the experimental structures of structural elements other than the target structural element are identical among all the evaluation tires;
measuring a radial force variation of each of the evaluation tires;
calculating a corrected radial-force variation of each of the evaluation tires by subtracting a 1st order component of the radial force variation from the radial force variation;
determining a structure of the target structural element based on the corrected radial-force variations of the evaluation tires; and
selecting another structural element from among the structural elements as a new target structural element and repeating the preparing, the measuring, the obtaining, and the determining for the new target structural element thereby determining structures of all the structural elements.

6. A method of manufacturing a tire comprising:
preparing a plurality of evaluation tires, each of the evaluation tires having a plurality of structural elements including a target structural element, such that an experimental joining position where edges of the target structural element are joined is different among all the evaluation tires, the experimental joining positions of the evaluation tires corresponding to positions where the tire is divided into parts with respect to a rotation axis of the tire, while structures of structural elements other than the target structural element are identical among all the evaluation tires;
measuring a radial force variation of each of the evaluation tires;
calculating a corrected radial-force variation of each of the evaluation tires by subtracting a 1st order component of the radial force variation from the radial force variation;
determining a joining position of the target structural element based on the corrected radial-force variations of the evaluation tires; and
selecting another structural element from among the structural elements as a new target structural element and repeating the preparing, the measuring, the obtaining, and the determining for the new target structural element thereby determining joining positions of all the structural elements; and
joining the edges of each of the structural elements at the joining positions determined at the determining.
